(19) United States
(12) Patent Application Publication
(10) Pub. No.: US 2025/0376322 A1
(43) Pub. Date: Dec. 11, 2025

(54) Trash Container with Compression Arrangement

(71) Applicant: Nine Stars Group (U.S.A.) Inc., Ontario, CA (US)

(72) Inventors: Shi Ping Wang, Ontario, CA (US); Jiangqun Chen, Fuzhou (CN); Youxi Luo, Fuzhou (CN)

(73) Assignee: Nine Stars Group (U.S.A.) Inc., Ontario, CA (US)

(21) Appl. No.: 18/735,181

(22) Filed: Jun. 6, 2024

(51) Int. Cl. B65F 1/14; B65F 1/16

(52) U.S. Cl. CPC B65F 1/1405; B65F 1/163

(57) ABSTRACT

A compression arrangement of a trash container includes at least one compression panel pivotally mounted on a bin body and configured to be moved between a normal state that is extending upright and a compression state that is pivotally and downwardly into a receiving cavity of a bin body of the trash container about a pivotal axis of the compression panel. By flipping the compression panel from the normal state to the compression state, any upper garbage contained in an upper portion of receiving cavity is compressed by the compression panel with respect to a bottom wall of the bin body to move to a lower portion of the receiving cavity and compress lower garbage contained in the lower portion of the receiving cavity.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The invention relates a trash container, and more particularly to a trash container with compression arrangement for selectively compressing the garbage contained therein to reduce an occupying volume thereof, so as to improve a utilization rate of containing space in trash bag as well as the trash container.

### Description of Related Arts

Most garbage to be disposed in the conventional trash bin are fluffy garbage such as napkins, cardboards, office wastepaper, plastic bags, and the like, which occupy much room of the interior cavity of the trash bin or the trash bag to be placed in the trash bin. Generally, a trash bin can only hold a small amount of garbage before it is full, so it is necessary to dump the garbage more frequently. Also, the plastic made trash bags cannot be used effectively, resulting in a waste of resources. Therefore, how to effectively compress the garbage disposed in the trash bin to minimize the occupying volume of the garbage without complicating the configuration of the trash bin becomes a long felt need of the industry.

FIG. 24A and FIG. 24B illustrate a conventional compressible trash container, which comprises a compression frame P11 operated by pushing handle to push the compression frame P11 downwards vertically to compress the garbage disposed in the interior cavity P12 of the trash container. However, such conventional compressible trash container is not practical because, during actual operation, the compression frame fails to evenly press and push down in a balance manner and is often stuck in the middle of the interior cavity, that requires significant effort to reposition the compression frame and causes extremely inconvenient in use.

FIG. 25 illustrates another conventional compressible trash container, which comprises an air bag P21 at a bottom of a lid P22, and the air bag P21 can be deformed in a vertical direction by inflating and deflating to directly or indirectly compress the garbage contained in the trash container. This structure solves the conventional problem of being jammed frequently during the compression operation, but it is unreasonably complex and the manufacturing cost is high, so that it is not conducive and beneficial to the market and the consumers. In addition, it does not make sense to inflate the air bag P21 manually every time and thus electrical power and air pump are necessary components that substantially increases the manufacturing and maintenance costs thereof.

### SUMMARY OF THE PRESENT INVENTION

The invention is advantageous in that it provides a trash container equipped with a compression arrangement for selectively compressing the trash contained therein to reduce an occupying volume thereof, so as to improve a utilization rate of containing space in trash bag as well as the trash container.

Another advantage of the invention is to provide a trash container equipped with a compression arrangement which is simple in structure with minimize manufacturing cost and is easy and simple to operate.

Another advantage of the invention is to provide a compression arrangement for a trash container which does not require to change much of the configuration of the trash container while effectively providing a compression ability to the garbage contained in the trash container anytime as desired.

Another advantage of the invention is to provide an inner trash bin equipped with a compression arrangement which is adapted to simply replace the original inner trash bin of existing trash container to provide the garbage compression function.

Another advantage of the invention is to provide a trash container with compression arrangement which is adapted to be operated to compress the garbage contained therein manually by hand or by foot.

Another advantage of the invention is to provide a trash container which compression arrangement is adaptable to be equipped with electric actuation mechanism to operate as desired or after each closing operation of the cover lid of the trash container.

Another advantage of the invention is to provide a trash container with compression arrangement which is configured to effectively compress the garbage contained therein in an effortless manner, by means of a pivotal action and torque force.

Another advantage of the invention is to provide a trash container with compression arrangement, which does not require any guiding mechanism nor any complicated transmission mechanism, while preventing any jamming during the compression process.

Another advantage of the invention is to provide a trash container with compression arrangement which greatly improves the utilization rate of the containing volume of the trash container as well as the trash bag to be placed in the trash container.

Additional advantages and features of the invention will become apparent from the description which follows and may be realized by means of the instrumentalities and combinations particular point out in the appended claims.

According to the present invention, the foregoing and other objects and advantages are attained by a trach container, comprising:
a bin body having a bottom wall and a surrounding wall upwardly extended from the bottom wall to form a top opening and define a receiving cavity between the bottom wall and the top opening therein; and
a compression arrangement comprising at least one compression panel pivotally mounted on the bin body and configured to be moved between a normal state that is extending upright and a compression state that is pivotally and downwardly into the receiving cavity about a pivotal axis of the at least one compression panel, wherein the receiving cavity is defined to have a lower portion below the pivotal axis and an upper portion above the pivotal axis, such that by flipping the at least one compression panel from the normal state to the compression state, any upper garbage contained in the upper portion of the receiving cavity is compressed by the at least one compression panel with respect to the bottom wall of the bin body to move to the lower portion of the receiving cavity and compress lower garbage contained in the lower portion of the receiving cavity.

In one embodiment, a height of the compression panel is preferred to be equal to or slightly less than a width of the upper portion of the receiving cavity.

In one embodiment, the compression arrangement further comprises an elongated pivot joint, wherein at least one upper actuation window is formed in the surrounding wall and the compression panel is mounted in the upper actuation window by means of the pivot joint such that the elongated pivot joint defines the pivotal axis and the at least one compression panel is pivotally flipped about the elongated pivot joint. In addition, when the compression panel is in the normal state, the compression panel covers the upper actuation window and is configured as a part of the surrounding wall of the bin body.

In one embodiment, the elongated pivot joint is an elongated hinge unit having one end connected to a bottom edge of the at least one compression panel and another end connected to a connecting edge of the actuation window, wherein the pivot joint is configured to support the at least one compression panel to upwardly extend in the normal state and allow the at least one compression panel being flipped in and down towards the lower portion of the receiving cavity to the compression state.

In one embodiment, the elongated pivot joint is an elongated resilient element, such as rubber, having one end connected to the bottom edge of the at least one compression panel and another end connected to the connecting edge of the actuation window, such that the resilient element normally supports the at least one compression panel to upwardly extend in the normal state while allows the at least one compression panel being flipped in and down toward the lower portion of the receiving cavity about the resilient element to the compression state.

In one embodiment, the at least one compression panel is able to be flipped down inwardly by an actuation force applied thereto, and that either the hinge unit or the resilient element of the pivot joint provides a resilient force to move the at least one compression panel back to the upright normal state after the actuation force is released.

In one embodiment, the compression arrangement further comprises a reposition mechanism configured to drive the at least one compression panel back to the normal state thereof.

In one alternative mode of the embodiment, the compression arrangement comprises a pair of compression panels pivotally mounted on two opposing sides of the bin body and each is configured to be moved between a normal state that is extending upright and a compression position pivotally and downwardly into the receiving cavity about a pivotal axis of the corresponding compression panel, wherein by flipping the pair of compression panels from their normal state to their compression state, the upper garbage contained in the upper portion of the receiving cavity is compressed by the pair of compression panels with respect to the bottom wall of the bin body to move to the lower portion of the receiving cavity and compress lower garbage contained in the lower portion of the receiving cavity.

In the alternative mode, a height of each of the pair of the compression panels is preferred to be equal to or slightly less than half a width of the upper portion of the receiving cavity, such that when the pair of the compression panels are flipped down to the compression state thereof, the two compression panels are positioned between the upper portion and the lower portion of the receiving cavity and cover the lower portion of the receiving cavity.

In the alternative mode, the compression arrangement further comprises a pair of elongated pivot joints and a pair of upper actuation windows are formed in the opposing sides of the surrounding wall and the two compression panels are mounted in the two upper actuation windows by means of the two pivot joints such that each of the two pivot joints defines the pivotal axis thereof and the two compression panels are pivotally flipped about the two pivot joints respectively. In addition, when the two compression panels are in their normal upright state, the two compression panels cover the upper actuation windows respectively and are configured as parts of the surrounding wall of the bin body.

In the alternative mode, each of the elongated pivot joint is an elongated hinge unit having one end connected to a bottom edge of the corresponding compression panel and another end connected to a connecting edge of the corresponding actuation window, wherein each of the pivot joints is configured to support the corresponding compression panel to upwardly extend in the normal state and allow the corresponding compression panel being flipped in and down towards the lower portion of the receiving cavity to the compression state.

In the alternative mode, each of the elongated pivot joints is an elongated resilient element, such as rubber, having one end connected to the bottom edge of the corresponding compression panel and another end connected to the connecting edge of the corresponding actuation window, such that the resilient element normally supports the corresponding compression panel to upwardly extend in the normal state while allows the corresponding compression panel being flipped in and down toward the lower portion of the receiving cavity about the corresponding resilient element to the compression state.

In the alternative mode, each of the pair of the compression panels is able to be flipped down inwardly by an actuation force applied thereto, and that either the hinge unit or the resilient element of the corresponding pivot joint provides a resilient force to move the corresponding compression panel back to the upright normal state after the actuation force is released.

In the alternative mode, the compression arrangement further comprises a reposition mechanism configured to drive the pair of the compression panels to reposition to the normal state thereof.

In the alternative mode, the pair of the compression panels is symmetrically arranged on a left side and a right side of the bin body, so that when compressing garbage, the operation is more convenient, and the compression forces applied by the compression panels are relatively balanced and will not deflect left or right and channeling so as to ensure a more stable compression,

In one embodiment, the compression arrangement further comprises an actuation mechanism configured for the user to actuate the at least one compression panel between the normal state and the compression state.

In one embodiment, the reposition mechanism is adapted to ensure the at least one compression panel to flip back and reposition to the normal state thereof, wherein the pivot joint of the reposition mechanism can be embodied as an engaging point and slot structure, a resilient pin structure, a resilient rubber structure, a torsion spring structure and the like, which is configured to ensure the at least one compression panel returning to the normal state thereof, i.e. positioned at an upper half of the bin body, after flipping in and down to the compression state thereof, and stably remaining in the normal state thereof without swaying or dangling.

In one embodiment, the engaging point and slot structure or resilient pin structure type pivot joint is configured to allow the user to manually reset the at least one compression panel and the resilient rubber structure and torsion spring structure type pivot joint relies on its own resilient force to complete the resetting of the at least one compression panel in an automatic reset manner.

In one embodiment, the compression arrangement further comprises a mounting mechanism for mounting a trash bag in the receiving cavity of the bin body.

In one embodiment, when there is only one compression panel, the mounting mechanism comprises mounting elements arranged at the top opening of the bin body and the compression panel and configured to hold, such as by clamping, the opening edge of the trash bag and retain the trash bag in an open condition in such a manner that the trash bag will not interference the flipping in and own movement of the compression panel during the compression operation thereof.

In one embodiment, when a pair of the compression panels are embodied, both the two mounting elements of the mounting mechanism are arranged on both the compression panels respectively for holding both side of the opening edge of the trash bag and retaining the trash bag in the open condition in such a manner that the trash bag will not interference the flipping in and down movement of the compression panels during the compression operation thereof.

In one embodiment, the actuation mechanism comprises at least one handle arranged on the at least one compression panel and configured for the user to push to flip the at least one compression panel in and down about the pivotal axis to the compression state thereof or to pull to flip the at least one compression panel back to the normal state thereof in upright position about the pivotal axis. The pushing down force of the at least one compression panel substantially helps to press down and compress the garbage contained in the receiving cavity of the bin body.

In one embodiment, the actuation mechanism comprises a step-operated actuating device which is embodied to allow the user to operate the at least one compression panel between the normal state and the compression state thereof by foot.

In one embodiment, the actuation mechanism comprises a step pedal device and a transmission apparatus, wherein the step pedal device is hinged to a lower portion of an outer container of the trash container and the transmission apparatus comprises at least one pivotal actuator pivotally connected to a middle portion of the outer container of the trash container, and at least one transmission element connecting the step pedal device and the at least one pivotal actuator to allow the step pedal device to drive the pivotal actuator to move pivotally to drive the at least one compression panel to move from the normal state thereof to the compression state thereof.

In one embodiment, the actuation mechanism further comprises a repositioning torsion spring which is used as the reposition mechanism and configured to be pivotally coupled with the at least one compression panel at the upper portion of the outer container. Correspondingly, the step pedal device also comprises a first torsion spring in the lower portion of the outer container and the transmission element also provides a second torsion spring in the middle portion of the outer container. The repositioning torsion spring, the first torsion spring and the second torsion spring significantly distribute the actuation force to reposition the corresponding components, such as the at least one compression panel, the pedal of the step pedal device and the transmission element, facilitate a balance of the repositioning mechanism and the actuation mechanism during repositioning operation of the at least one compression panel and the pedal, and prevent excess inertia of the at least one compression panel during the repositioning operation thereof, so that the strength of the upper portion of the bin body does not need to be too high that is conducive to the design of the bin body.

In one embodiment, the bin body is disposed in the outer container and positioned adjacent to an inner side of the at least one transmission element, such that the compression operation of the garbage contained in the bin body includes steps of:
stepping on the step pedal of the step pedal device with a foot of the user;
driving the step pedal device to rotate downwards and, at the same time, driving the at least one transmission element to rotate inward through a pulling effect of the at least one transmission element;
exerting a force to the at least one compression panel by the at least one pivotal actuator;
driving the at least one compression panel to flip in and down about the pivotal axis to press down and compress the garbage contained in the upper portion of the receiving cavity that further compresses the garbage contained in the lower portion of the receiving cavity; and
releasing the step pedal device after the compression is completed, by means of the torque resilient ability of the repositioning torsion spring, the first torsion spring and the second torsion spring, the step pedal device, the at least one transmission element, the at least one pivotal actuator, and the at least one compression panel return to normal states thereof.

In accordance with another aspect of the invention, the present invention providing a compression method of a trash container, comprising:
providing at least one compression panel pivotally mounted on a bin body;
moving the at least one compression panel from a normal state, that is extending upright, to a compression state where the at least one compression panel is pivotally and downwardly into a receiving cavity about a pivotal axis of the compression panel to press down and compress any upper garbage contained in an upper portion of the receiving cavity with respect to a bottom wall of the bin body to move to a lower portion of the receiving cavity and compress lower garbage contained in the lower portion of the receiving cavity; and
returning the at least one compression panel to the normal state.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a trash container according to a preferred embodiment of the invention.

FIG. 2 is a sectional view of the trash container according to the preferred embodiment of the invention.

FIG. 2A is a sectional view illustrating an alternative bin body of the trash container as shown in FIG. 1 and FIG. 2 according to the preferred embodiment of the invention.

FIG. 2B is a sectional view illustrating an alternative pivot joint of the trash container as shown in FIG. 2 and FIG. 3 according to the preferred embodiment of the invention.

FIG. 3 is an exploded view of the trash container according to the preferred embodiment of the invention.

FIG. 4 is a perspective view of a trash container according to a first alternative mode of the preferred embodiment of the invention.

FIG. 5 is a perspective view illustrating a trash bag mounted in the trash container according to the first alternative mode of the preferred embodiment of the invention.

FIG. 6 is a sectional view of the trash container according to the first alternative mode of the preferred embodiment of the invention.

FIG. 7 is an exploded view of the compression panel of the trash container according to the preferred embodiment of the invention.

FIG. 8 is a sectional view illustrating the mounting of the opening edge of the trash bag to the compression panel according to the preferred embodiment of the invention.

FIG. 9 is another sectional view illustrating the mounting of the opening edge of the trash bag to the compression panel according to the preferred embodiment of the invention.

FIG. 10 is a perspective view of a trash container according to a second alternative mode of the preferred embodiment of the invention.

FIG. 11 is an exploded view of the trash container according to a second alternative mode of the preferred embodiment of the invention.

FIG. 12 is a partial sectional perspective view of the trash container according to the second alternative mode of the preferred embodiment of the invention.

FIG. 13 is a sectional view illustrating the mounting of a trash bag in the trash container according to the second alternative mode of the preferred embodiment of the invention.

FIG. 14 is a sectional view illustrating a compression operation of the pair of compression panels of the trash container according to the second alternative mode of the preferred embodiment of the invention.

FIG. 15 is a perspective view of a trash container according to a third alternative mode of the preferred embodiment of the invention.

FIG. 16 is another view of the trash container according to the third alternative mode of the preferred embodiment of the invention.

FIG. 17 an exploded view of the trash container according to the third alternative mode of the preferred embodiment of the invention.

FIG. 18 is a perspective view of a bin body of the trash container according to the third alternative mode of the preferred embodiment of the invention.

FIG. 19 is an exploded view of the bin body of the trash container according to the third alternative mode of the preferred embodiment of the invention.

FIG. 20 is a perspective view of the outer container of the trash container according to the third alternative mode of the preferred embodiment of the invention.

FIG. 21 is a partially sectional perspective view illustrating the mounting of a trash bag in the bin body of the trash container according to the third alternative mode of the preferred embodiment of the invention.

FIG. 22 is a partially sectional perspective view of the trash container according to the third alternative mode of the preferred embodiment of the invention.

FIG. 23 is a partially sectional perspective view illustrating the compression operation of the trash container according to the third alternative mode of the preferred embodiment of the invention.

FIG. 24A and FIG. 24B are schematic views illustrating a conventional compressible trash container.

FIG. 25 is a schematic view illustrating another conventional compressible trash container.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

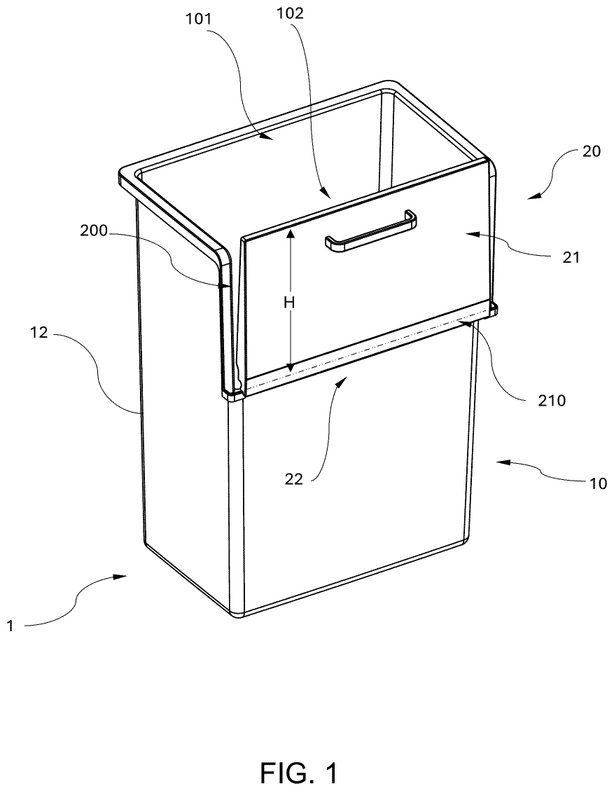

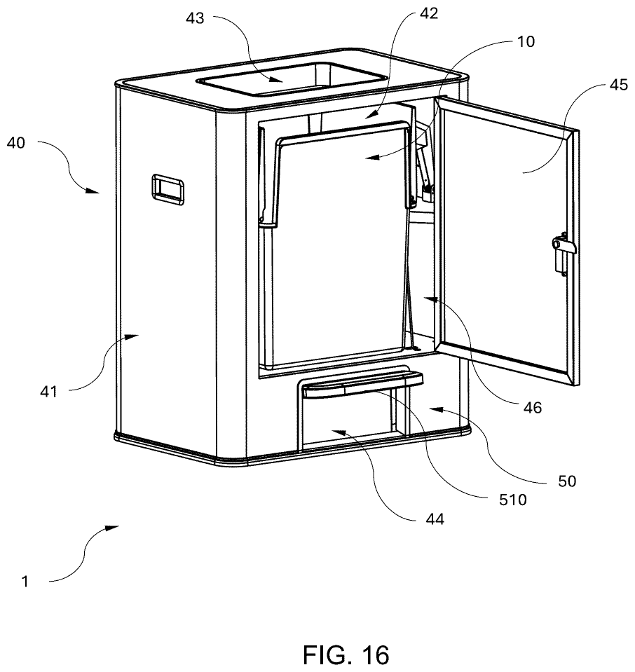

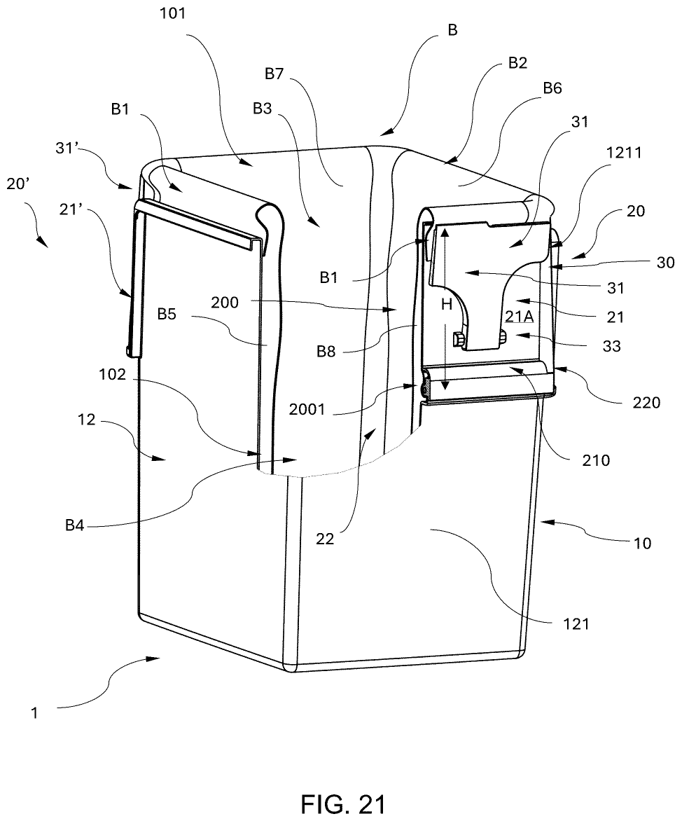

Referring to FIG. 1 to FIG. 23, the invention provides a trash container 1 comprising a bin body 10 and a compression arrangement 20 for selectively compressing the garbage contained therein to reduce an occupying volume thereof, so as to improve a utilization rate of containing space in the trash container 1 as well as the trash bag placed in the trash container 1.

The bin body 10 having a bottom wall 11 and a surrounding wall 12 upwardly extended from the bottom wall 11 to form a top opening 101 and define a receiving cavity 102 between the bottom wall 11 and the top opening 101 therein.

The compression arrangement 20 comprises at least one compression panel 21 pivotally mounted on the bin body 10 and configured to be moved between a normal state, that is extending upright, and a compression state, that is pivotally and downwardly into the receiving cavity about a pivotal axis 210 of the compression panel 21. The receiving cavity 102 is defined to have a lower portion 1021 below the pivotal axis 210 and an upper portion 1022 above the pivotal axis 210, such that by flipping the at least one compression panel 21 from the normal state to the compression state, any upper garbage contained in the upper portion 1022 of the receiving cavity 102 is compressed by the at least one compression panel 21 with respect to the bottom wall 11 of the bin body 10 to move to the lower portion 1021 of the receiving cavity 102 and compress lower garbage contained in the lower portion 1021 of the receiving cavity 102.

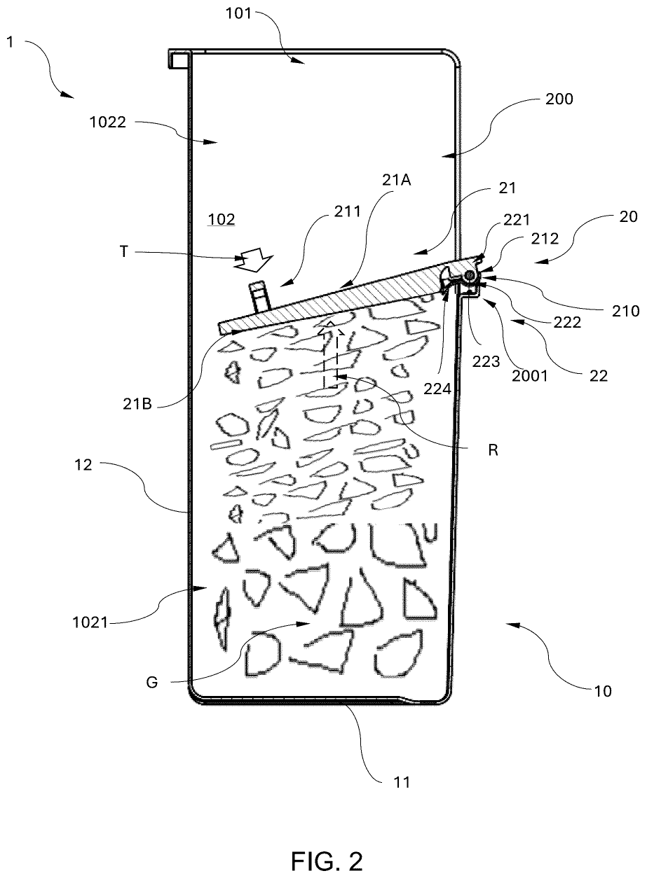

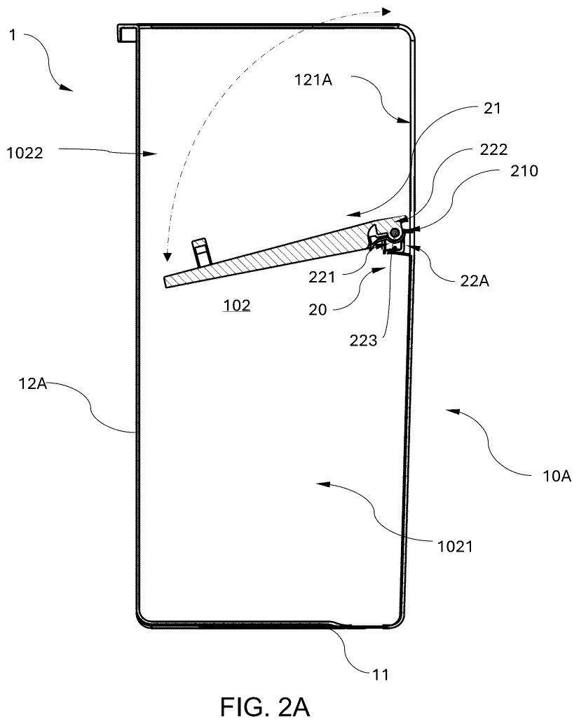

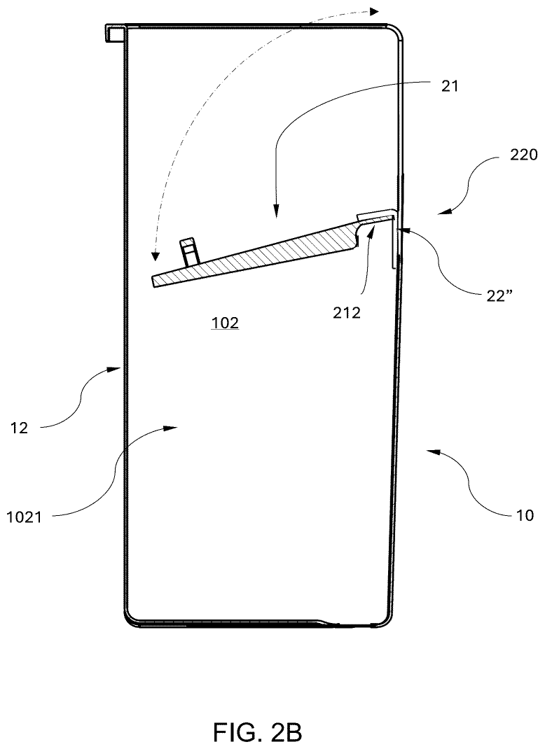

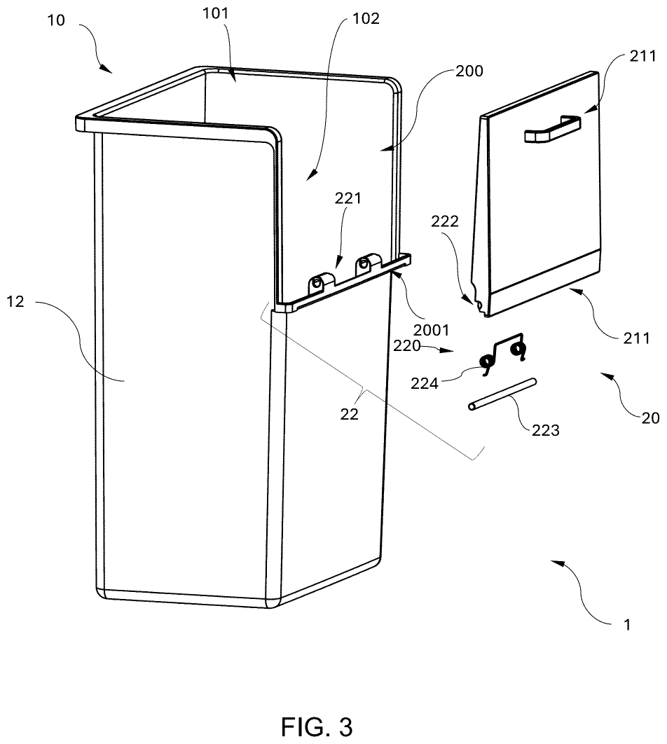

Referring to FIG. 1, FIG. 2 and FIG. 3, the trash container 1 is embodied to have a simplest configuration for disposing garbage directly therein, that comprises merely the bin body 10, wherein a height H of the compression panel 21 is preferred to be equal to or slightly less than a width of the upper portion 1021 of the receiving cavity 102. Further, the compression arrangement 20 comprises an elongated pivot joint 22 and at least one upper actuation window 200 is formed in the surrounding wall 12 of the bin body 10, wherein the compression panel 21 is mounted in the upper actuation window 200 by means of the pivot joint 22 such that the elongated pivot joint 22 defines the pivotal axis 210 and the at least one compression panel 21 is pivotally flipped about the elongated pivot joint 22. In addition, when the compression panel 21 is in the normal state, the compression panel 21 covers the upper actuation window 200 and is configured as a part of the surrounding wall 12 of the bin body 10, as shown in FIG. 1.

The pivot joint 22 is configured to support the at least one compression panel 21 to upwardly extend in the normal state (as shown in FIG. 1) and allow the at least one compression panel 21 being flipped in and down towards the lower portion 1021 of the receiving cavity 102 to the compression state (as shown in FIG. 2).

Referring to FIG. 2, a compression operation of the garbage and trash G contained in the receiving cavity 102 of the bin body 10 of the trash container 1 is as simple as moving the at least one compression panel 21 from the normal state (e.g. extending upright as shown in FIG. 1) to the compression state by pushing the at least one compression panel 21 towards the lower portion 1021 of the receiving cavity 102, wherein the at least one compression panel 21 is pivotally and downwardly into a receiving cavity 102 about the pivotal axis 210 of the compression panel 21 to press down and compress any upper garbage G contained in an upper portion 1022 of the receiving cavity 102 with respect to the bottom wall 11 of the bin body 10 to move to the lower portion 1022 of the receiving cavity 102 and compress the lower garbage G contained in the lower portion 1022 of the receiving cavity 102, and then returning the at least one compression panel 21 from the compression state to the normal state by pulling the at least one compression panel 21 upwardly and pivotally about the pivotal axis 210 back to its upright position of the normal state thereof.

In other words, the flipping up and down of the at least one compression panel 21 is accomplished through a pivotal action by rotating about the pivotal axis 210 thereof, that is the pivot joint 22. The height of the at least one compression panel 21 forms a torque radius about the pivotal axis 210 to enable to user to press down the at least one compression panel 21 to compress the fluffy garbage or trash G contained in the upper portion 1022 of the receiving cavity 102 of the bin body 10 with a torque force. Further, the down pressing movement of the garbage or trash G into the lower portion 1021 of the receiving cavity 102 of the bin body 10 also substantially compress the original garbage or trash G in the lower portion 1021 of the receiving cavity 102 of the bin body 10.

According to the preferred embodiment of the invention, the at least one compression panel 21 further comprises a handle 211 mounted on an outer side 21A thereof, adjacent to a top edge thereof, while an inner side 21B of the at least one compression panel 21 forms a compression surface to compress the garbage and trash G during the compression operation of the at least one compression panel 21.

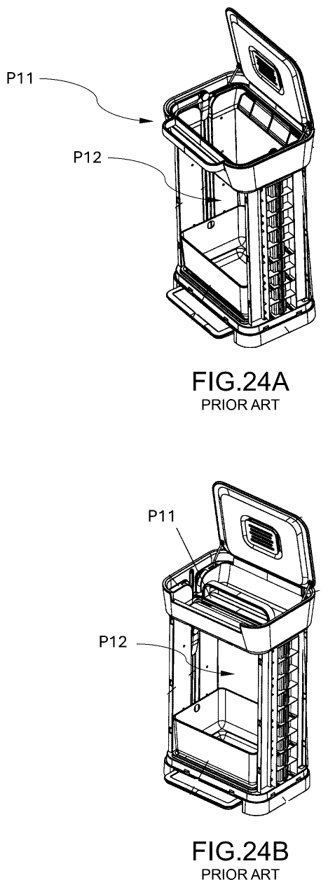

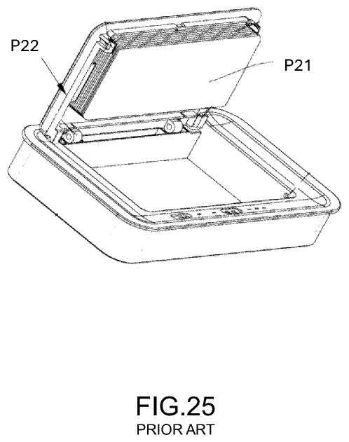

In comparison to the conventional garbage compression mechanism as illustrated in FIG. 24A to FIG. 25, wherein the garbage is downwardly compressed vertically where a pushing force larger than the reaction force has to be applied, the invention takes advantage of the torque distance, i.e. the height H of the at least one compression panel 21, the torque actuation force T applied to the handle 211 of the at least one compression panel can be much smaller than the upward reaction force R applied to the at least one compression panel 21, as shown in FIG. 2, such that the garbage and trash G contained in the receiving cavity 102 of the bin body 10 can be compressed in an effortless manner according to the present invention.

It is appreciated that when the bin body 10 is empty, the garbage or trash G thrown into the receiving cavity 102 is disposed in the lower portion 1021 until the garbage or trash G fills up the lower portion 1021 of the receiving cavity 102. Then, the garbage or trash G starts to pile up in the upper portion 1022 of the receiving cavity 102, wherein the user may manually flip down the at least one compression panel 21 by rotating about the pivotal axis 210 to press and compress the garbage or trash G in the upper portion 1022 into the lower portion 1021 of the receiving cavity 102 that will further compress the garbage or trash G contained in the lower portion 1021 of the receiving cavity 102 of the bin body 10, such that the occupying volume of the garbage or trash G is compressed and reduced to provide more receiving space for the receiving cavity 102 to store more garbage and trash.

Accordingly, the compression arrangement 20 equipped in the trash container 1 of the invention is simple in structure with minimize manufacturing cost and is easy and simple to operate. That is the trash container 1 of the invention does not require to change much of the configuration of the trash container while effectively providing a compression ability to the garbage contained in the trash container anytime as desired.

It is worth mentioning that the trash container 1, as shown in FIG. 1, FIG. 2 and FIG. 3, can be used to replace the original inner trash bin of existing trash can to provide the garbage compression function.

FIG. 2A illustrates an alternative configuration of the trash container 1 as shown in FIG. 1 and FIG. 2, wherein the surrounding wall 12A of the bin body 10A does not have the actuation window 200 and the at least one compression panel 21 is pivotally connected to an inner side 121A of the surrounding wall 12A through the pivot joint 22A and performs the garbage compression function as mentioned above.

The pivot joint 22 has one end connected to a bottom edge 212 of the at least one compression panel 21 and another end connected to a connecting edge 2001 of the actuation window 200, wherein the pivot joint 22 is configured to support the at least one compression panel 21 to upwardly extend in the normal state and allow the at least one compression panel 21 being flipped in and down towards the lower portion 1021 of the receiving cavity 102 to the compression state.

Referring to FIG. 1 to FIG. 3, according to the preferred embodiment of the invention, the pivot joint 22 is embodied as an elongated hinge unit which comprises a tubular first hinge member 221 formed along the connecting edge 2001 of the actuation window 200, a tubular second hinge member 222 formed along the bottom edge 212 of the at least one compression panel 21, a pivot axle 223 configured to penetrate through the first and second hinge members 221, 222 so as to pivotally connect the bottom edge 212 of the at least one compression panel 21 to the connecting edge 2001 of the actuation window 200 of the bin body 10, and a panel torsion spring 224 configured to be mounted on the pivot axle 223 to provide a resilient force to retain the at least one compression panel 21 in the normal state and to automatically drive the at least one compression panel 21 from the compression state returning to the normal state after an actuation pushing force applied to the at least one compression panel 21 is released.

As shown in FIG. 2B, it is worth mentioning that, alternatively, In one embodiment, the elongated pivot joint 22 is an elongated resilient element 22″, such as rubber, having one end connected to the bottom edge of the at least one compression panel 21 and another end connected to the surrounding wall 12, such as the connecting edge 2001 of the actuation window 200, such that the resilient element 22″ normally supports the at least one compression panel 21 to upwardly extend in the normal state while allows the at least one compression panel 21 being flipped in and down toward the lower portion 1021 of the receiving cavity 12 about the resilient element 22″ to the compression state.

In other words, the panel torsion spring 224 of the pivot joint 22 or the resilient element 22″ contributed a reposition mechanism 220 of the trash container 1 for driving the at least one compression panel 21 to the normal state thereof. By means of the reposition mechanism 220, the at least one compression panel 21 is able to be flipped down inwardly by the actuation force T applied thereto, and that either the hinge unit 22 or the resilient element 22″ of the pivot joint 22 provides a resilient force to move the at least one compression panel 21 back to the upright normal state after the actuation force T is released.

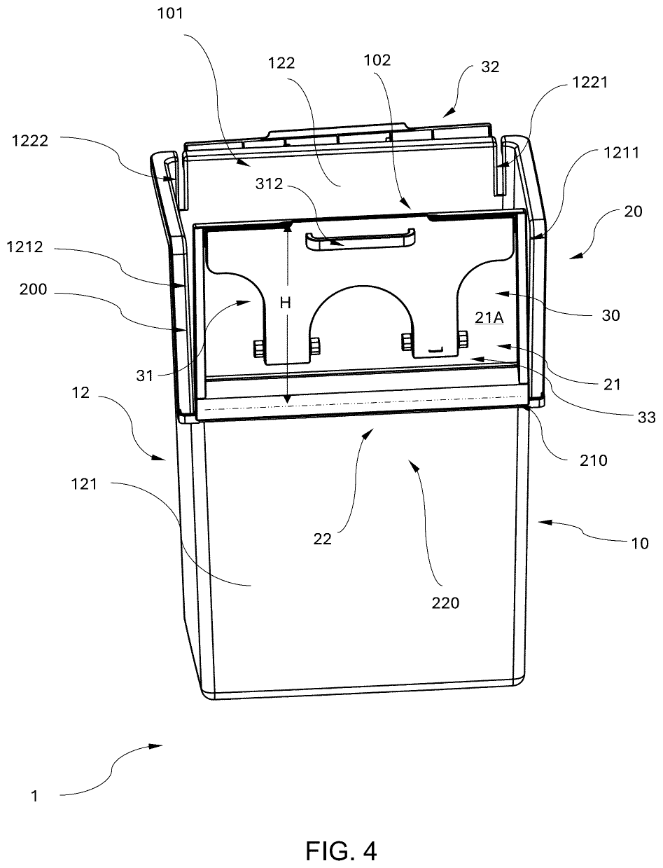

When a trash bag B is required to place inside the receiving cavity 102 of the trash container 1, the compression arrangement 20 of the invention is embodied to further comprises a mounting mechanism 30 for mounting the trash bag B in position without interference to the compression operation of the at least one compression panel 21. Referring to FIG. 4 to FIG. 9, a first alternative mode of the preferred embodiment of the invention is illustrated, wherein the bin body 10 is embodied as a rectangular shape and the surrounding wall 12 bin body 10 is embodied as to have a front side 121 and a rear side 122, wherein the actuation window 200 is formed in an upper portion of the front side 121 of the surrounding wall 12 and a pair of mounting slots 1221, 1222 vertically and respectively extended from two end portions of a top edge of the rear side 122 of the surrounding wall 12 of the bin body 10 for a predetermined depth.

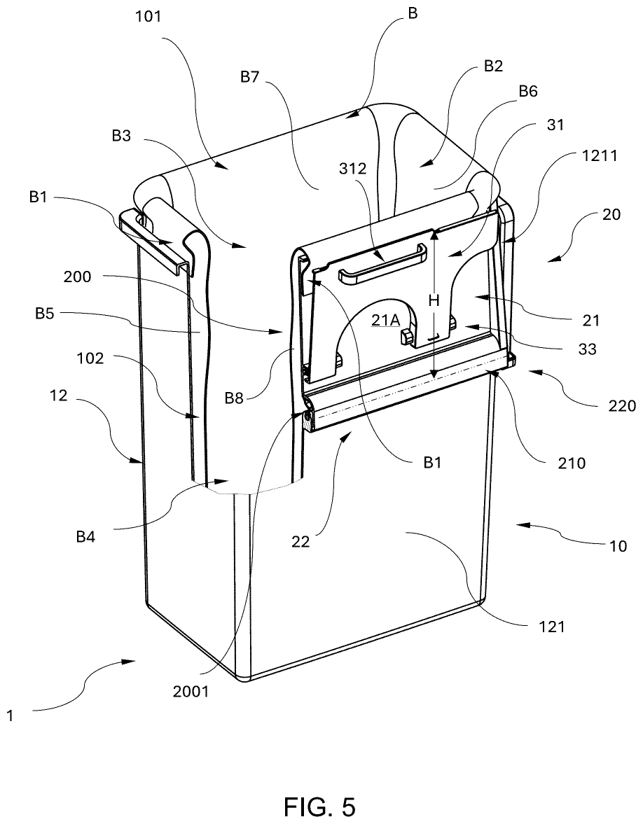

Referring to FIG. 4 and FIG. 5, the mounting mechanism 30 includes the pair of mounting slots 1221, 1222 of the rear side 122 of the surrounding wall 12 and two mounting gaps 1211, 1212 formed between two end sides of the compression panel 21 and the two side edges of the actuation windows 200, such that a mouth portion B1 of the trash bag B, generally made of plastic, placed in the receiving cavity 102 of the bin body 10, as shown in FIG. 5, can be turned around and sleeved on the top portion of the at least one compression panel 21 via the two mounting gaps 1211, 1212 and the top portion of the rear side 122 of the surrounding wall 12 via the pair of mounting slots 1221, 1222, such that the generally parallel rear side 122 of the surrounding wall 12 and the upright compression panel 21 in the normal state substantially retains a mouth opening B2 of the trash bag B in open condition. In other words, through bypassing the mouth portion B1 of the trash bag B on the rear side 122 of the surrounding wall 12 of the bin body 10 and the compression panel 21, a rear portion of the mouth portion B1 of the trash bag B is sleeved at the top edge, between the two mounting slots 1221, 1222, of the rear side 122 of the surrounding wall 12 of the bin body 1, and a front portion of the mouth portion B1 of the trash bag B is sleeved at an upper portion of the compression panel 21, so that the front portion and the rear portion of the mouth portion B1 of the trash bag B are straightened by the rear side 122 of the surrounding wall 12 of trash container 1 and the compression panel 21 so as to retain the opening mouth B2 of the trash bag B generally equal to the size of the top opening 101 of the bin body 10 for ease of disposing garbage or trash into the trash bag B.

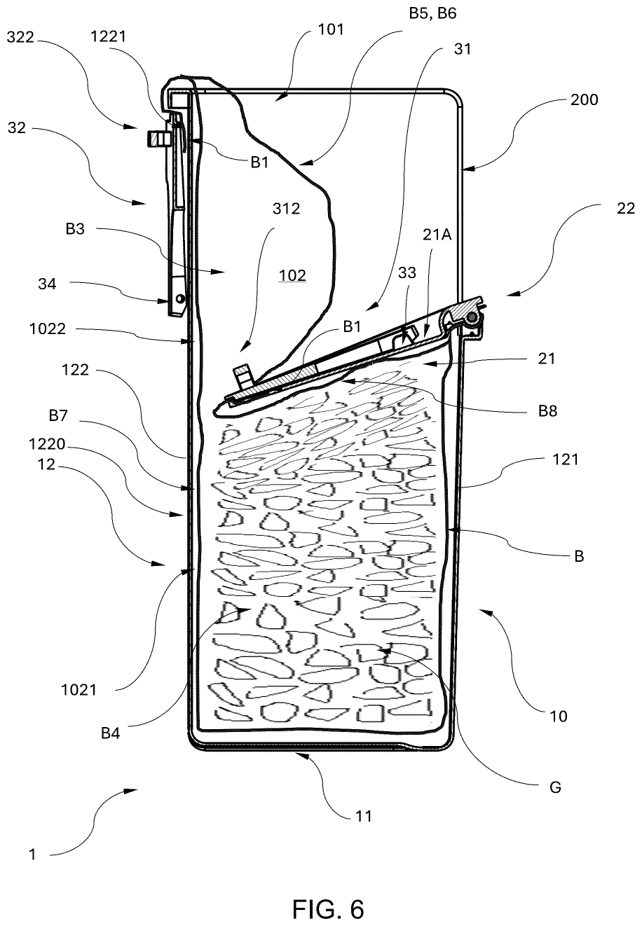

Referring to FIG. 5 to FIG. 9, in order to further securely mount the trash bag B with the rear side 122 of the surrounding wall 12 and the compression panel 21, the mounting mechanism 30 further comprises first and second presser members 31, 32, each of which is embodied as a pressing plate, pivotally mounted to the outer side 21A of the compression panel 21 and an outer surface 1220 of the rear side 122 of the surrounding wall 12 (as shown in FIG. 6) by means of two resilient hinge units 33, 34. Each of the resilient hinge unit 33, 34 comprises a hinge base 331, 341 configured to pivotally hinge with a pivot end 311, 321 of the presser member 31, 32 and at least one first torque spring 332, 342 mounted between the pivot end 311, 321 and the hinge base 331, 341 to provide a resilient force pressing against the outer side 21A of the compression panel 21 and the outer surface 1220 of the rear side 122 of the surrounding wall 12 of the bin body 10.

According to the first alternative mode of the preferred embodiment, referring to FIG. 6, the handle 211 as shown in FIG. 3 is replaced by a first handle 312 connected to a distal end of the first presser member 31 and a second handle 322 is also provided on a distal end of the second presser member 32, such that the first and second handles 312, 322 are adapted for the user to pull the first and second presser members 31, 32 pivotally away from the outer side 21A of the compression panel 21 and the outer surface 1220 of the rear side 122 of the surrounding wall 12 about the resilient hinge units 33, 34 respectively to place the corresponding mouth portion B1 of the trash bag B between the first presser member 31 and the outer side 21A of the compression panel 21 as well as the outer surface 1220 of the rear side 122 of the surrounding wall 12. When the pulling forces applied to the first and second handles 312, 322 are released, the torque springs 332, 342 of the resilient hinge units 33, 34 provide repositioning spring forces to the first and second presser members 31, 32 respectively to ensure the first presser member 31 pressing against the outer side 21A of the compression panel 21 and the second presser member 32 pressing against the outer surface 1220 of the rear side 122 of the surrounding wall 12 so as to securely press and retain the mouth portion B1 in position and thus securely mounting the trash bag B in bin body 10.

Referring to FIG. 5 to FIG. 7, according to the present alternative mode of the preferred embodiment of the invention, the compression panel 21 is pivotally connected to the connecting edge 2001 of the actuation window 200 formed in an upper portion of the front side 121 of the surrounding wall 12 by means of the pivot joint 22 in such a manner that the compression panel 21 is normally retained in its upright normal state and can be flipped inwardly and downwardly about the pivotal axis 210 (the pivot joint 22), as shown in FIG. 6, to compress the upper garbage and trash G in an upper space B3 of the trash bag B in the upper portion 1022 into a lower space B4 of the trash bag B in the lower portion 1021 of the receiving cavity 102 of the bin body 10, wherein when the compression panel 21 is flipping in and down, the left and right sides B5, B6 of the trash bag B are flexibly driven inwards by the compression panel 21 while the rear side B7 of the trash bag B is retained to the rear side 122 of the surrounding wall 12 of the bin body 10 through the mounting slots 1221, 1222 as shown in FIG. 4. Further, according to the first alternative mode, the rear side B7 of the trash bag B is further retained to be securely mounted to the rear side 122 of the surrounding wall 12 of the bin body 10 by the presser member 32.

It is worth to mentioning that the first handle 312 not only helps the user to operate the presser member 31 but also facilitates the user to hold and pivotally press down the compression panel 21 by applying the torque force T thereto to compress the garbage and trash G with the compression panel 21 together with a front side B8 of the trash bag B.

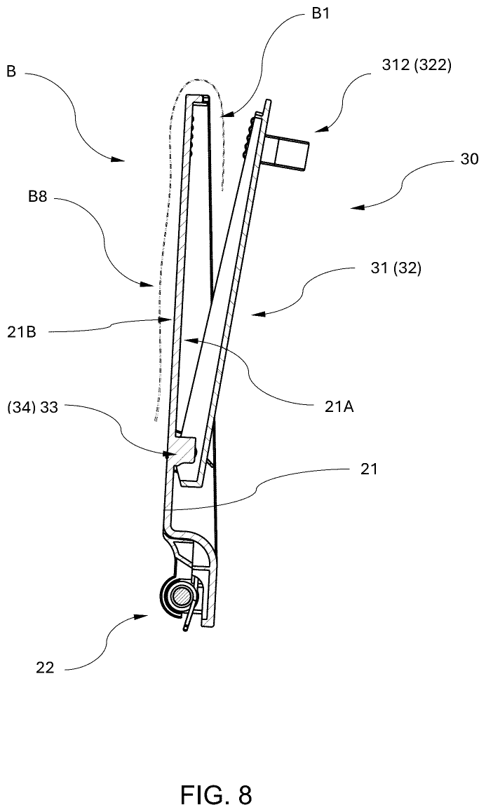

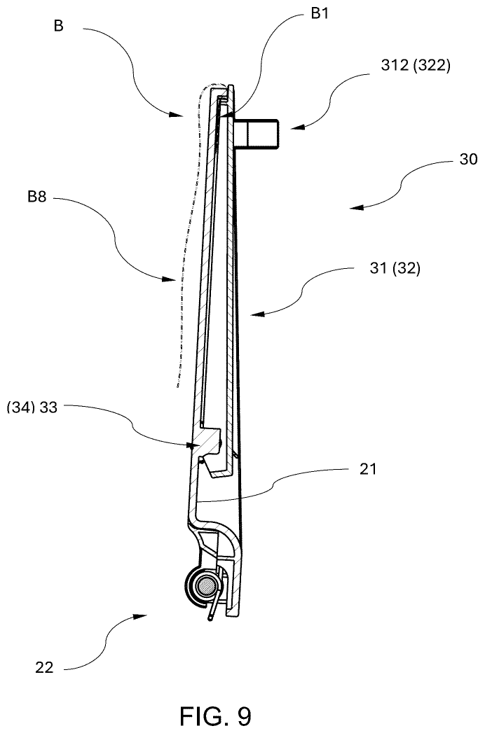

Further, referring to FIG. 8 and FIG. 9, taking the first presser member 31 as an example (the second presser member 32 works similarly), to secure the mouth portion B1 of the front side B8 of the trash bag B with the first presser member 31 (as well as the rear side B7 of the trash bag B with the second presser member 32), the user may simply pull outwardly the first handle 312 (second handle 322) to form a clearance, such that the mouth portion B1 can be placed between the compression panel 21 and the first presser member 31, as shown in FIG. 8. Then, after the pulling force applied to the first presser member 31 (second presser member 32) is released, the first presser member 31 presses against the compression panel 21 (the second presser member 332 presses against the outer surface 1220 of the rear side 122 of the surrounding wall 12) to securely mount the mouth portion B1 in position.

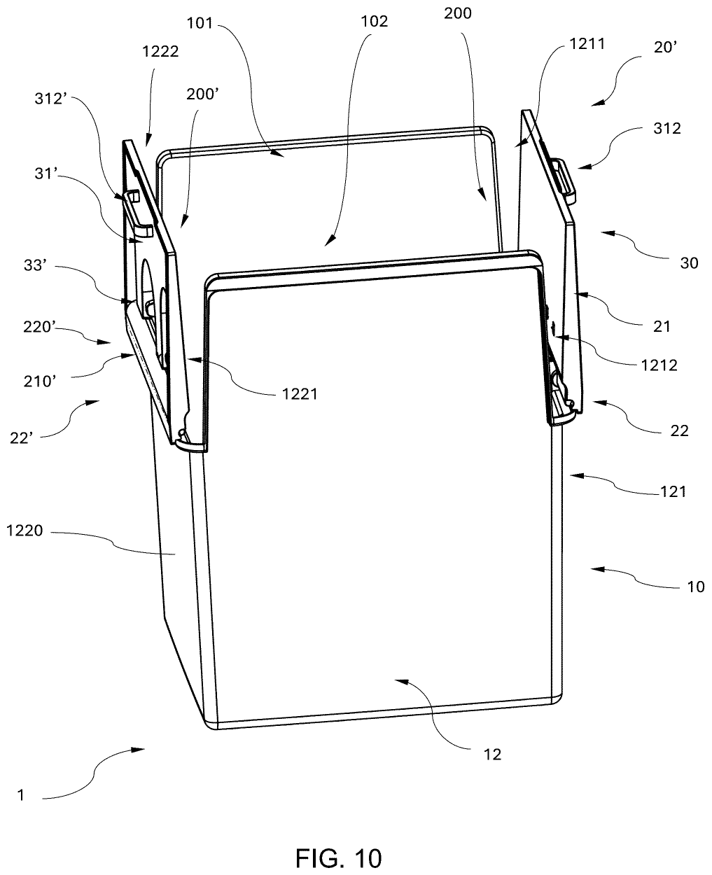

Referring to FIG. 10 to FIG. 14, a second alternative mode of the preferred embodiment of the invention is illustrated, wherein the compression arrangement 20′ of the second alternative mode is modified from the first alternative mode as shown in FIG. 4 to FIG. 9, to have a pair of compression panels 21, 21′. Correspondingly, each of the front side 121 and the rear side 122 of the surrounding wall 12 of the bin body 10 forms the actuation window 200, 200′ to install the pair of compression panels 21, 21′ therein in a pivotal manner.

The configuration and operation of the compression panel 21 is the same as that of the disclosure in the first alternative mode as shown in FIG. 4 to FIG. 9. Similarly, the other compression panel 21′ is preferred to be configured the same as the compression panel 21 and pivotally mounted to the connecting edge 2001 of the actuation window 200′ formed in the rear side 122 of the surrounding wall 12 of the bin body 10 in the same manner. However, the height H of each of the pair of compression panels 21, 21′ is equal to or slightly less than a distance between the front side 121 and the rear side 122 of the surrounding wall 12 of the bin body 10. Such configuration as disclosed in the second alternative mode is preferred to be used in a larger size bin body 10, such as square shape, to ensure convenient and effective compression operation of the garbage and trash G contained in the bin body 10 with less effort by means of the pair of compression panels 21, 21′.

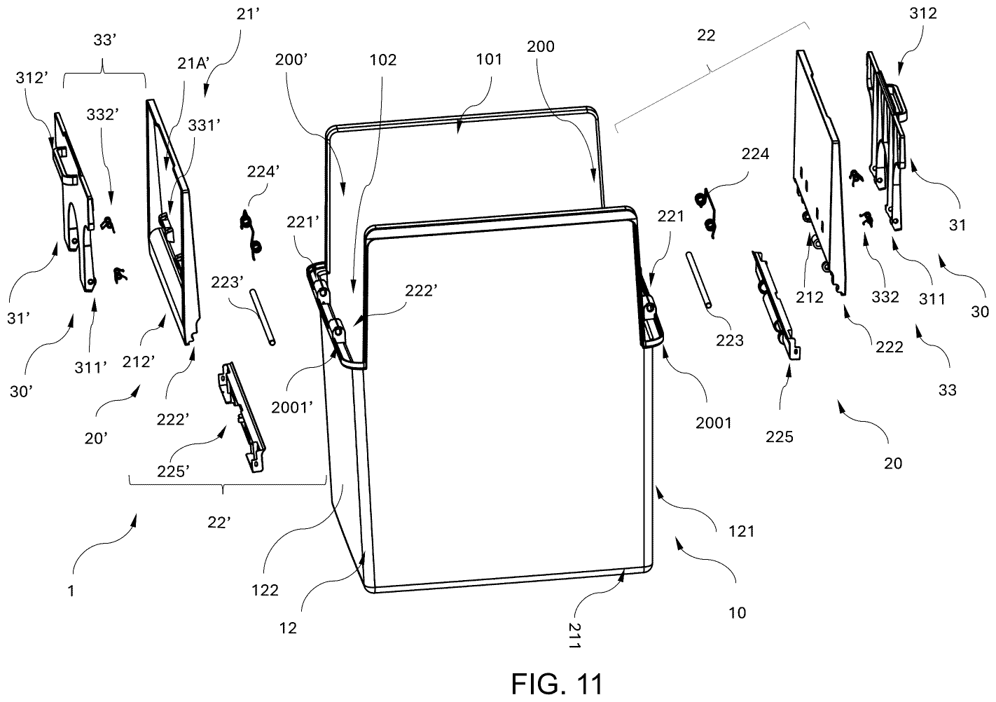

Similarly, referring to FIG. 10 and FIG. 11, the other compression panel 21′ is pivotally mounted to the connecting edge 2001′ of the actuation window 200′ provided in the rear side 122 of the surrounding wall 12 of the bin body 10 by another pivot joint 22′ and configured to be moved between a normal state, that is extending upright, and a compression state, that is pivotally and downwardly into the receiving cavity 102 about a pivotal axis 210′ of the compression panel 21′. Therefore, by flipping the two compression panels 21, 21′ from their normal state to the compression state, any upper garbage contained in the upper portion 1022 of the receiving cavity 102 is compressed by the at least one compression panel 21 with respect to the bottom wall 11 of the bin body to move to the lower portion 1021 of the receiving cavity 102 and compress lower garbage contained in the lower portion 1021 of the receiving cavity 102.

The pivot joint 22′ defines the pivotal axis 210′ and the compression panel 21′ 10 is pivotally flipped about the elongated pivot joint 22′.

When the pair of the compression panels 21 are in their normal state, the two compression panels 21, 21′ covers the upper actuation windows 200, 200′ in the front and rear sides 121, 122 of the surrounding wall 12 and is configured as parts of the surrounding wall 12 of the bin body 10, as shown in FIG. 10.

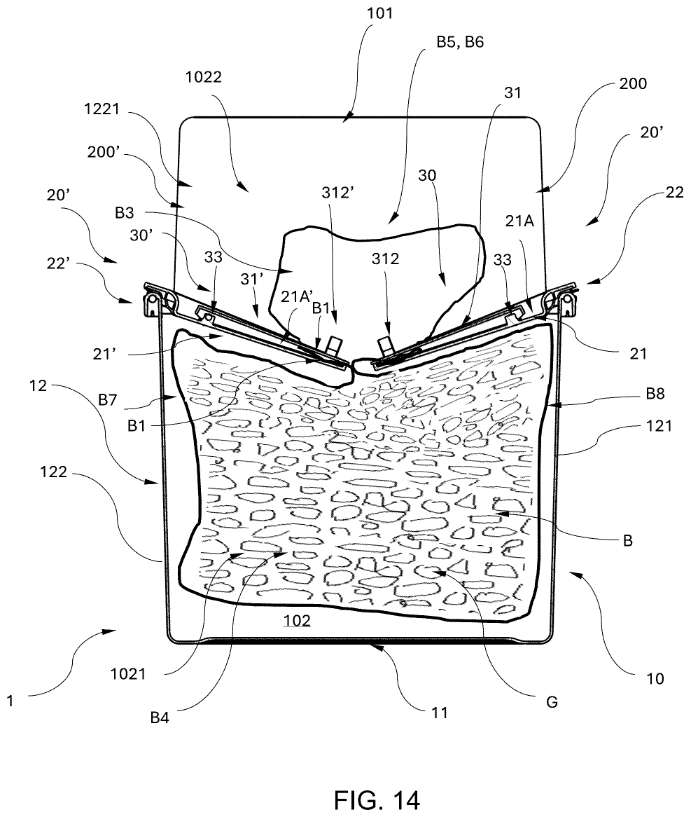

The pivot joint 22′ is configured to support the other compression panel 21′ to upwardly extend in the normal state (as shown in FIG. 10) and allow the compression panel 21′ being flipped in and down towards the lower portion 1021 of the receiving cavity 102 to the compression state (as shown in FIG. 14).

Similarly, the pivot joint 22′ also has one end connected to a bottom edge 212′ of the other compression panel 21′ and another end connected to a connecting edge 2001′ of the actuation window 200′, wherein the pivot joint 22′ is configured to support the other compression panel 21′ to upwardly extend in the normal state and allow the other compression panel 21′ being flipped in and down towards the lower portion 1021 of the receiving cavity 102 to the compression state.

Referring to FIG. 11, the pivot joint 22′ is also embodied as an elongated hinge unit which comprises a tubular first hinge member 221′ formed along the connecting edge 2001′ of the actuation window 200′, a tubular second hinge member 222′ formed along the bottom edge 212′ of the other compression panel 21′, a pivot axle 223′ configured to penetrate through the first and second hinge members 221′, 222′ so as to pivotally connect the bottom edge 212′ of the other compression panel 21′ to the connecting edge 2001′ of the actuation window 200′ in the rear side 122 of the surrounding wall 12 of the bin body 10, and a panel torsion spring 224′ configured to be mounted on the pivot axle 223′ to provide a resilient force to retain the other compression panel 21′ in the normal state and to automatically drive the other compression panel 21′ from the compression state returning to the normal state after an actuation pushing force applied to the other compression panel 21′ is released.

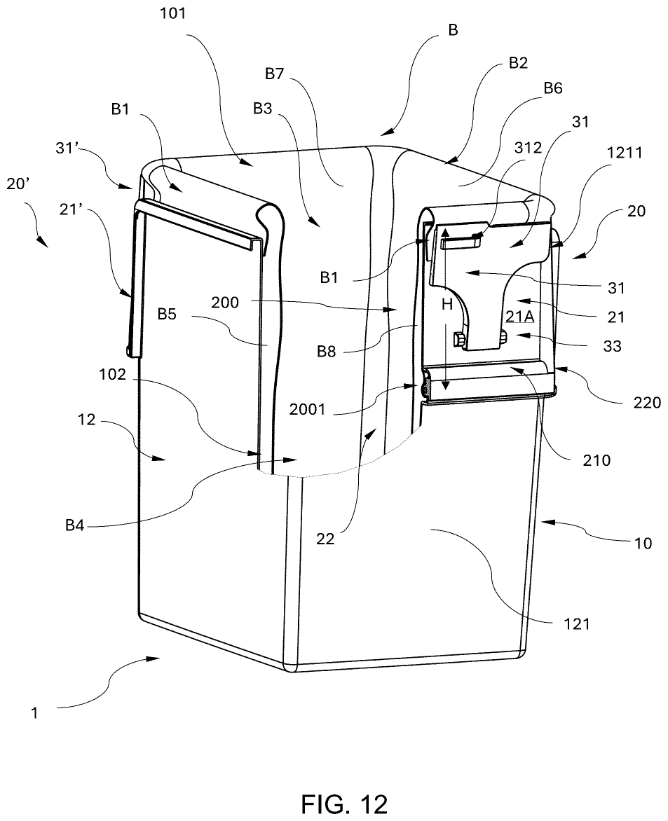

Further, referring to FIG. 10 and FIG. 12, the mounting mechanism 30 includes two mounting gaps 1211, 1212 formed between two end sides of the compression panel 21 and the two side edges of the actuation windows 200 formed in the front side 121 of the surrounding wall 12, and another two mounting gaps 1221, 1222 formed between two end sides of the other compression panel 21′ and two side edges of the actuation windows 200′ formed in the rear side 122 of the surrounding wall 12, such that the mouth portion B1 of the trash bag B, generally made of plastic, placed in the receiving cavity 102 of the bin body 10, as shown in FIG. 5, can be turned around and sleeved on the top portions of the two compression panels 21, 21′ via the two pairs of the mounting gaps 1211, 1212, 1221, 1222, wherein the two upright compression panel 21, 21′ in the normal state substantially retains the mouth opening B2 of the trash bag B in open condition, so that the front portion and the rear portion of the mouth portion B1 of the trash bag B are straightened by the two upright compression panels 21, 21′, as shown in FIG. 12, so as to retain the opening mouth B2 of the trash bag B generally equal to the size of the top opening 101 of the bin body 10 for ease of disposing garbage or trash into the trash bag B.

Referring to FIG. 10 and FIG. 11, in order to further securely mount the trash bag B with the two compression panel 21, 21′, the mounting mechanism 30 also comprises two presser members 31, 31′, each of which is embodied as a pressing plate, pivotally mounted to the outer sides 21A, 21A′ of the two compression panels 21, 21′ respectively by means of two resilient hinge units 33, 33′. Each of the resilient hinge unit 33, 33′ comprises a hinge base 331, 331′ configured to pivotally hinge with a pivot end 311, 311′ of the presser member 31, 31′ and at least one first torque spring 332, 332′ mounted between the pivot end 311, 311′ and the hinge base 331, 331′ to provide a resilient force pressing against the outer side 21A, 21A of the compression panel 21, 21′.

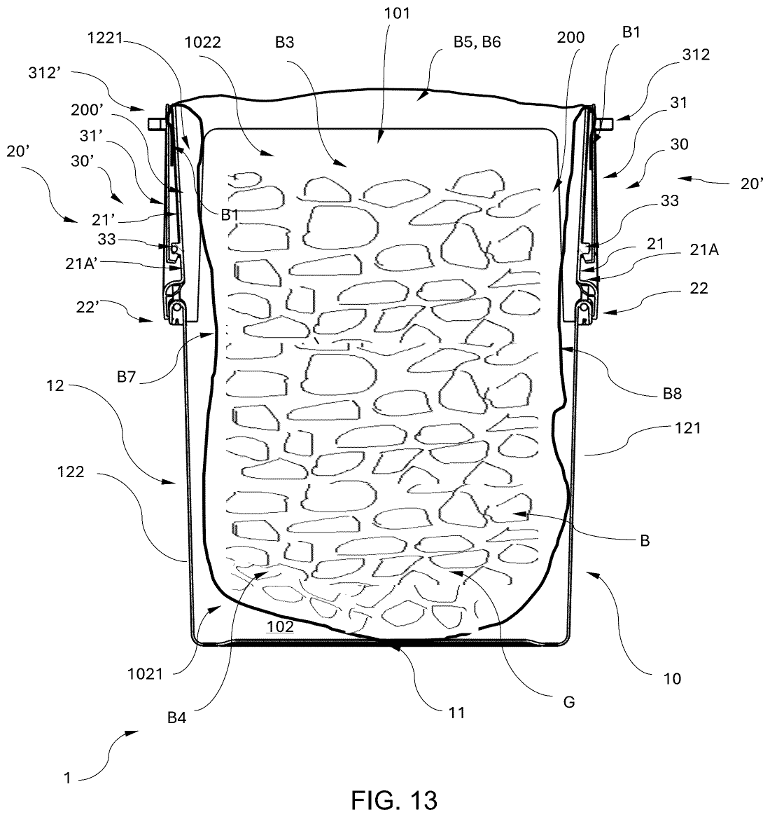

According to the third alternative mode of the preferred embodiment, referring to FIG. 11 and FIG. 13, both presser members 31, 31′ also have the handle 312, 312′ mounted thereon for the user to pull the presser members 31, 31′ pivotally away from the outer sides 21A, 21A′ of the two compression panels 21, 21′ respectively to place the corresponding mouth portion B1 of the trash bag B between the presser members 31, 31′ and the outer sides 21A, 21A′ of the two compression panel 21, 21′. When the pulling forces applied to the handles 312, 312′ are released, the torque springs 332, 332′ of the resilient hinge units 33, 33′ provide repositioning spring forces to the corresponding presser members 31, 31′ to ensure the presser members 31, 31′ pressing against the outer sides 21A, 21A′ of the compression panels 21, 21′ so as to securely press and retain the mouth portion B1 in position and thus securely mounting the trash bag B in bin body 10.

Referring to FIG. 12 to FIG. 14, according to the third alternative mode of the preferred embodiment of the invention, the two compression panels 21, 21′ are pivotally connected to the bottom edges 2001, 2001′ of the actuation windows 200, 200′ formed in the upper portions of the front side 121 and rear side 122 of the surrounding wall 12 respectively by means of the pivot joints 22, 22′ in such a manner that the pair of the compression panels 21, 21′ are normally retained in their upright normal states and can be respectively flipped inwardly and downwardly about their pivotal axes 210. 210′ to compress the upper garbage and trash G in an upper space B3 of the trash bag B in the upper portion 1022 into a lower space B4 of the trash bag B in the lower portion 1021 of the receiving cavity 102 of the bin body 10, wherein when the pair of the compression panels 21, 21′ are flipping in and down, the left and right sides B5, B6 of the trash bag B are flexibly driven inwards by the pair of the compression panels 21, 21′.

Both handles 312, 312′ not only help the user to operate the presser members 31, 31′ but also facilitate the user to respectively hold and pivotally press down the pair of the compression panels 21, 21′ by applying the torque forces T thereto to compress the garbage and trash G with the pair of the compression panels 21, 21′ together with front side B8 and rear side B7 of the trash bag B.

Also, to secure the mouth portion B1 of the front and rear sides B7, B8 of the trash bag B with the two presser members 31, 31′, the user may simply pull outwardly each of the two handles 312, 312′ to form a clearance, such that the mouth portion B1 can be placed between the two compression panels 21, 21′ and the two presser members 31, 31′. Similarly, after the pulling forces applied to the two presser members 31, 31′ are released, the two presser members 31, 31′ press against the two compression panels 21, 21′ respectively to securely mount the mouth portion B1 in position.

Referring to FIG. 13 and FIG. 14, a compression operation of the garbage and trash G contained in the receiving cavity 102 of the bin body 10 of the trash container 1 is also as simple as moving the pair of the compression panels 21, 21′ from their normal state (e.g. extending upright as shown in FIG. 13) to the compression state (as shown in FIG. 14) by pushing the two compression panels 21, 21′ towards the lower portion 1021 of the receiving cavity 102, wherein each of the compression panels 21, 21′ is pivotally and downwardly into a receiving cavity 102 about the pivotal axis 210 of each of the compression panels 21, 21′ to press down and compress any upper garbage G contained in an upper portion 1022 of the receiving cavity 102 with respect to the bottom wall 11 of the bin body 10 to move to the lower portion 1021 of the receiving cavity 102 and compress the lower garbage G contained in the lower portion 1021 of the receiving cavity 102, and then returning the two compression panels 21, 21′ from their compression state to the normal state by pulling each of the compression panels 21, 21′ upwardly and pivotally about the pivotal axis 210 back to its upright position of the normal state thereof.

In other words, the flipping up and down of the pair or the compression panels 21, 21′ is accomplished through a pivotal action by rotating about the pivotal axis 210 thereof, that is the pivot joint 22, 22′. The height of each of the two compression panels 21, 21′ forms a torque radius about the pivotal axis 210 to enable to user to press down the two compression panels 21, 21′ to compress the fluffy garbage or trash G contained in the upper portion 1022 of the receiving cavity 102 of the bin body 10 with a torque force. Similarly, the down pressing movement of the garbage or trash G into the lower portion 1021 of the receiving cavity 102 of the bin body 10 also substantially compress the original garbage or trash G in the lower portion 1021 of the receiving cavity 102 of the bin body 10.

Like the second alternative mode of the preferred embodiment of the invention, it is appreciated that when the bin body 10 is empty, the garbage or trash G thrown into the receiving cavity 102 is disposed in the lower portion 1021 until the garbage or trash G fills up the lower portion 1021 of the receiving cavity 102. Then, the garbage or trash G starts to pile up in the upper portion 1022 of the receiving cavity 102, wherein the user may manually flip down each of the compression panels 21, 21′ by rotating about its pivotal axis 210 to press and compress the garbage or trash G in the upper portion 1022 into the lower portion 1021 of the receiving cavity 102 that will further compress the garbage or trash G contained in the lower portion 1021 of the receiving cavity 102 of the bin body 10, such that the occupying volume of the garbage or trash G is compressed and reduced to provide more receiving space for the receiving cavity 102 to store more garbage and trash.

It is worth mentioning that the pair of the compression panels 21, 21′ is symmetrically arranged on a left side and a right side of the bin body 10, so that when compressing garbage, the operation is more convenient, and the compression forces applied by the compression panels 21, 21′ are relatively balanced and will not deflect left or right and channeling so as to ensure a more stable compression,

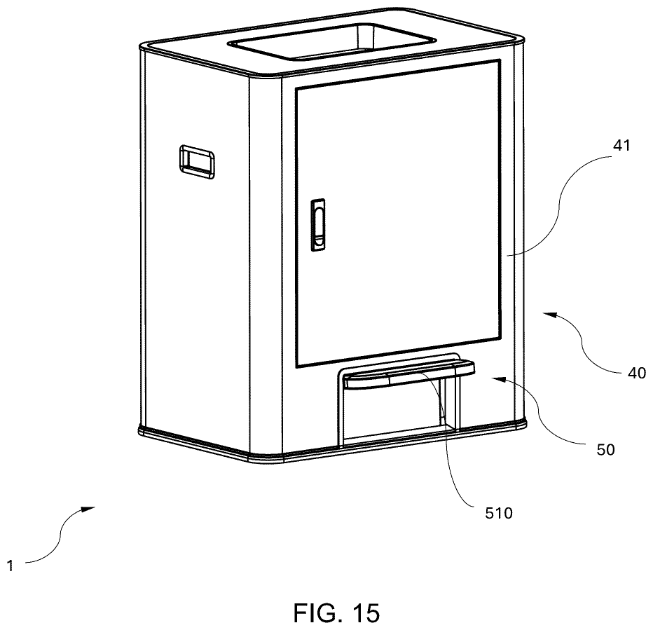

Referring to FIG. 15 to FIG. 23, a third alternative mode of the preferred embodiment of the invention is illustrated, wherein the actuation mechanism of the compression arrangement 20, embodied as the pair handles 312, 312′ of the above second alternative mode, is replaced by a step-operated actuation mechanism 50 for the user to actuate the at least one compression panel between the normal state and the compression state, and that the trash container 1 further comprises an outer container 40 to receive the bin body 10 and the actuation mechanism 50 therein.

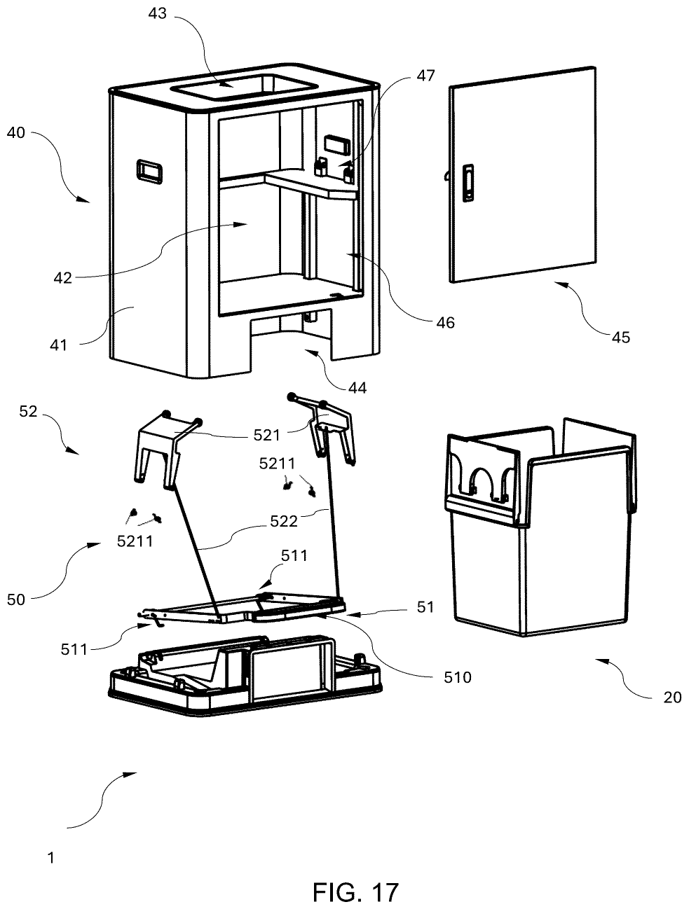

Referring to FIG. 17, the outer container 40 comprises a container body 41 having a bin chamber 42 defined therein, an opening 43 formed in a top side thereof, and a step window 44 formed at a bottom portion of a front side thereof. The outer container 40 may further comprises a door 45 configured to cover a front window 46 formed in the front side thereof.

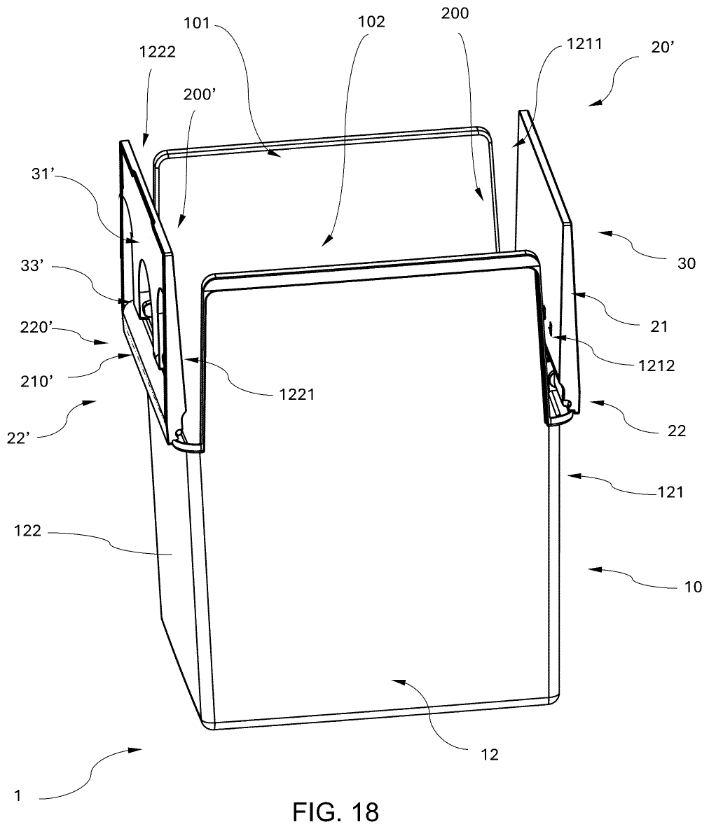

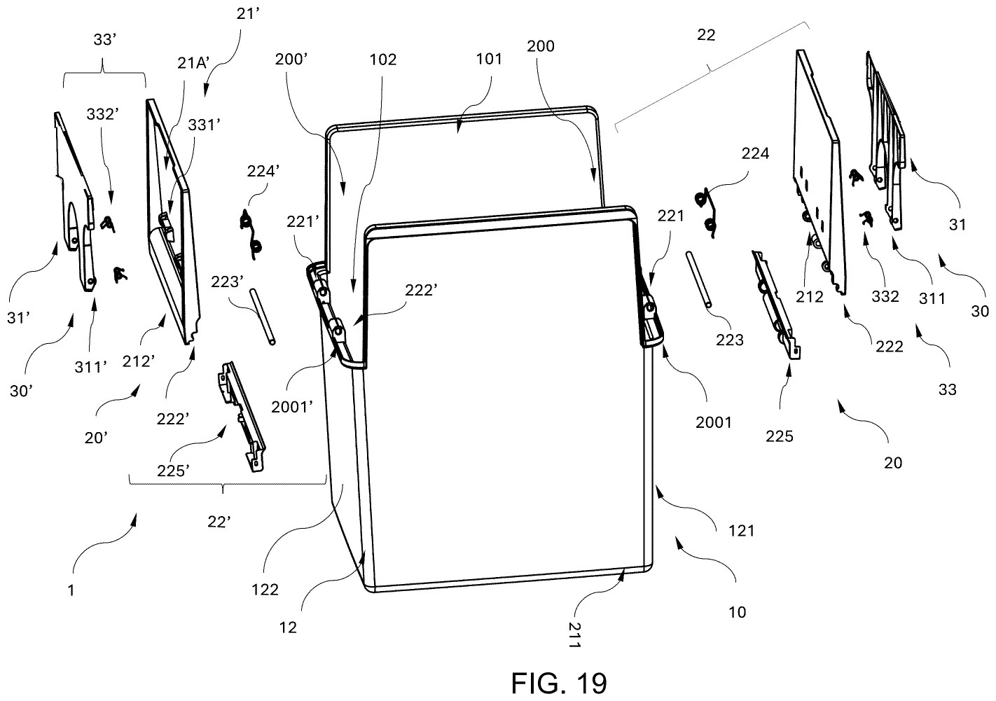

Referring to FIG. 18 and FIG. 19, the bin body 10 of the third alternative mode has the same structure of the bin body 10 of the second alternative mode as shown in FIG. 10 and FIG. 11, except no handle 312, 312′ is needed to be provided.

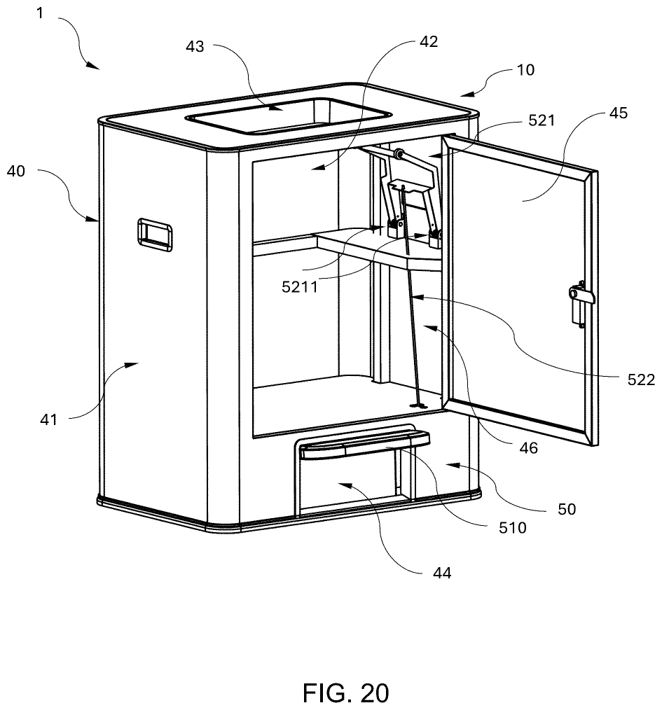

Referring to FIG. 17 and FIG. 20, the actuation mechanism 50 is embodied as a step-operated actuation mechanism 50 arranged to allow the user to operate the pair of the compression panel 21, 21′ between the normal state and the compression state thereof by foot.

The step-operated actuation mechanism 50 comprises a step pedal device 51 and a transmission apparatus 52, wherein the step pedal device 51 is hinged to a lower portion of the outer container 40 and comprises a pedal 510 exposed to outside through the step window 44 of the trash container 1. The transmission apparatus 52 comprises a pair of pivotal actuators 521 pivotally connected to a pair of hinges 47 provided at a middle portion of the outer container 40 of the trash container 1, and a pair of transmission elements 522 connecting the step pedal device 51 and the pivotal actuators 521 to allow the step pedal device 51 to drive the pair of the pivotal actuators 521 to push and move pivotally to drive the pair of the compression panels 21, 21′ respectively to move from the normal state thereof to the compression state thereof.

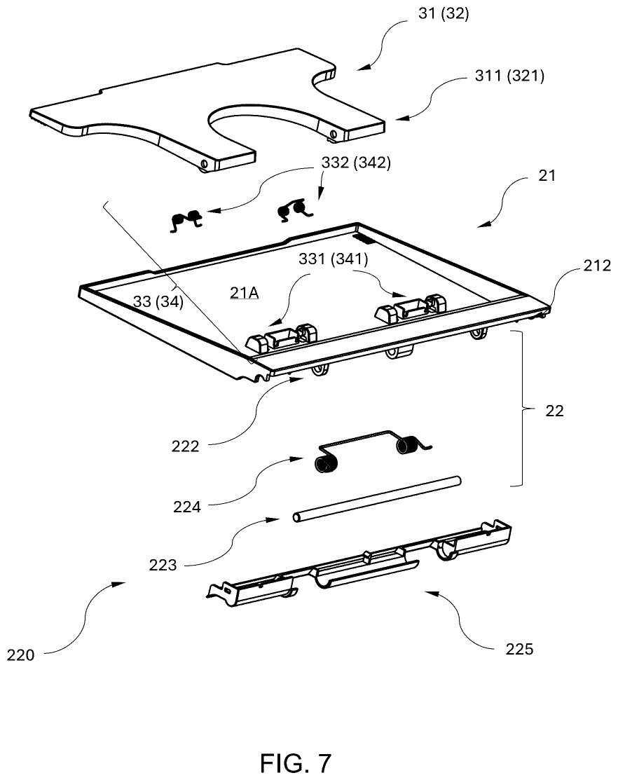

According to the third alternative mode, as shown in FIG. 17 and FIG. 20, the step pedal device 51 also comprises at least one, preferably a pair of first torsion springs 511 in the lower portion of the outer container 40 and the pair of the transmission elements 522 also provides two pairs of second torsion springs 5211 respectively in the middle portion of the outer container 40. The repositioning torsion springs 224, the first torsion springs 511 and the second torsion springs 5211, as shown in FIG. 7, significantly distribute the actuation force applied onto the pair of the two compression panels 21, 21′ by the pair of the pivotal actuators 521 to reposition the corresponding components, such as the two compression panels. 21, 21′, the pedal 510 of the step pedal device 51 and the transmission elements 522, facilitate a balance of the repositioning mechanism 220 and the actuation mechanism 50 during repositioning operation of the pair of the compression panels. 21. 21′ and the pedal 510, and prevent excess inertia of the pair of the compression panels 21, 21′ during the repositioning operation thereof, so that the strength of the upper portion of the bin body 10 does not need to be too high that is conducive to the design of the bin body 10.

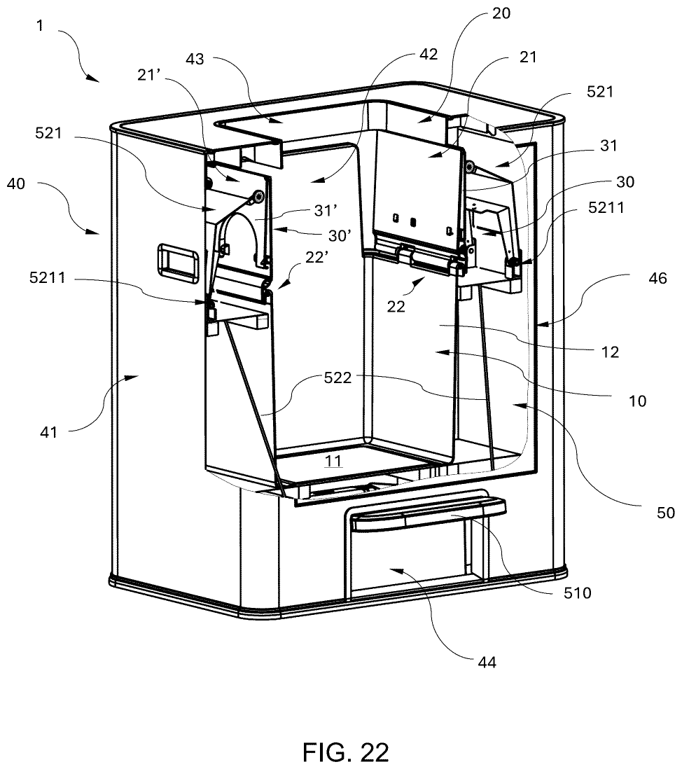

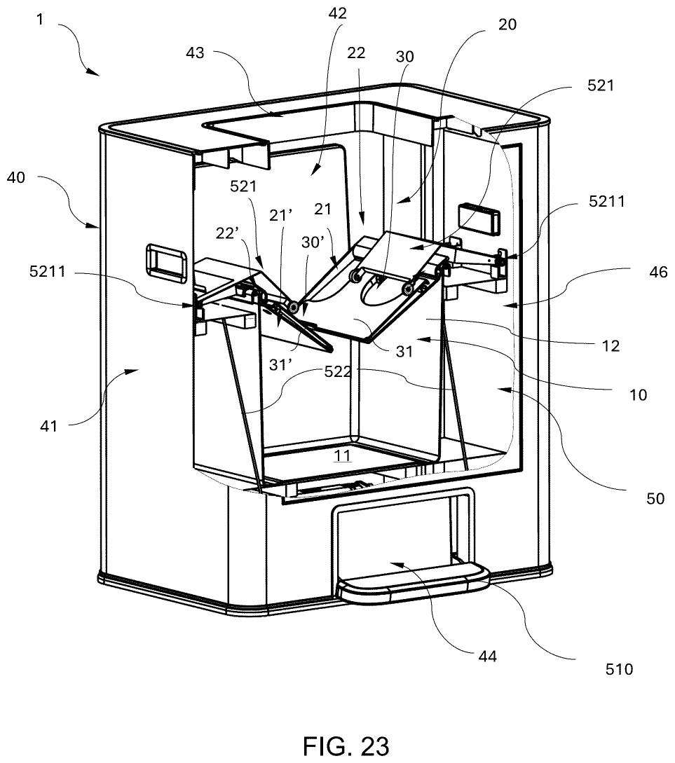

Referring to FIG. 22 and FIG. 23, the compression mechanism and operation of the pair of the compression panels 21, 21′ and the mounting mechanism 30, 30′ and operation of the trash bag B to the bin body 10 are the same of the second alternative mode as shown in FIG. 13 and FIG. 14, except the actuation of the pair of the compression panels 21, 21′ is conducted by means of the step-operated actuation mechanism 50 as disclosed in the third alternative mode through the step pedal 510.

In view of above, according to another aspect of the invention, the compression operation of the garbage and trash G contained in the bin body 10 includes steps of:
stepping on the step pedal 510 of the step pedal device 51 with a foot of the user;
driving the step pedal device 51 to rotate downwards and, at the same time, driving the transmission elements 522 to rotate inward through a pulling effect thereof;
exerting a force to the pair of the compression panels 21, 21′ by the pivotal actuators 521;
driving the pair of the compression panels 21, 21′ to flip in and down about the pivotal axis 210 to press down and compress the garbage and trash G contained in the upper portion 1022 of the receiving cavity 102 that further compresses the garbage and trash G contained in the lower portion 1021 of the receiving cavity 102; and
releasing the step pedal device 51 after the compression is completed, by means of the torque resilient ability of the repositioning torsion spring 224, 224′, the first torsion springs 511 and the second torsion springs 5211, the step pedal device 51, the pair of the transmission elements 522, the pair of the pivotal actuators 521, and the pair of the compression panels 21, 22 return to normal states thereof.

In accordance with another aspect of the invention, the present invention providing a compression method of the trash container 1, comprising:
providing the at least one compression panel 21 pivotally mounted on the bin body 10;
moving the at least one compression panel 21 from a normal state, that is extending upright, to a compression state where the at least one compression panel 21 is pivotally and downwardly into the receiving cavity 102 about the pivotal axis 210 of the at least one compression panel 21 to press down and compress any upper garbage contained in the upper portion 1022 of the receiving cavity 102 with respect to a bottom wall 11 of the bin body 10 to move to the lower portion 1021 of the receiving cavity 102 and compress lower garbage contained in the lower portion 1021 of the receiving cavity 102; and
returning the at least one compression panel 21 to the normal state.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A trach container, comprising:
a bin body having a bottom wall and a surrounding wall upwardly extended from the bottom wall to form a top opening and define a receiving cavity between the bottom wall and the top opening therein; and
a compression arrangement comprising at least one compression panel pivotally mounted on the bin body and configured to be moved between a normal state that is extending upright and a compression state that is pivotally and downwardly into the receiving cavity about a pivotal axis of the at least one compression panel, wherein the receiving cavity is defined to have a lower portion below the pivotal axis and an upper portion above the pivotal axis, such that by flipping the at least one compression panel from the normal state to the compression state, any upper garbage contained in the upper portion of the receiving cavity is compressed by the at least one compression panel with respect to the bottom wall of the bin body to move to the lower portion of the receiving cavity and compress lower garbage contained in the lower portion of the receiving cavity.

2. The trash container, as recited in claim 1, wherein a height of the compression panel is preferred to be equal to or slightly less than a width of the receiving cavity.

3. The trash container, as recited in claim 1, wherein the compression arrangement further comprises a pivot joint, wherein at least one upper actuation window is formed in the surrounding wall and the compression panel is mounted in the upper actuation window by means of the pivot joint, such that the pivot joint defines the pivotal axis and the at least one compression panel is pivotally flipped about the pivot joint.

4. The trash container, as recited in claim 2, wherein the compression arrangement further comprises at least one pivot joint, wherein at least one upper actuation window is formed in the surrounding wall and the compression panel is mounted in the upper actuation window by means of the at least one pivot joint, such that the at least one pivot joint defines the pivotal axis and the at least one compression panel is pivotally flipped about the pivot joint.

5. The trash container, as recited in claim 3, wherein the at least one pivot joint is an elongated hinge unit having one end connected to a bottom edge of the at least one compression panel and another end connected to a connecting edge of the actuation window, wherein the at least one pivot joint is configured to support the at least one compression panel to upwardly extend in the normal state and allow the at least one compression panel being flipped in and down towards the lower portion of the receiving cavity to the compression state.

6. The trash container, as recited in claim 4, wherein the at least one pivot joint is an elongated hinge unit having one end connected to a bottom edge of the at least one compression panel and another end connected to a connecting edge of the actuation window, wherein the at least one pivot joint is configured to support the at least one compression panel to upwardly extend in the normal state and allow the at least one compression panel being flipped in and down towards the lower portion of the receiving cavity to the compression state.

7. The trash container, as recited in claim 5, wherein the at least one compression panel is able to be flipped down inwardly by an actuation force applied thereto, and that the at least one pivot joint provides a resilient force to move the at least one compression panel back to the upright normal state after the actuation force is released.

8. The trash container, as recited in claim 6, wherein the at least one compression panel is able to be flipped down inwardly by an actuation force applied thereto, and that the at least one pivot joint provides a resilient force to move the at least one compression panel back to the upright normal state after the actuation force is released.

9. The trash container, as recited in claim 1, wherein at least one compression panel is pivotally mounted in the actuation window formed in an upper portion of a front side of the surrounding wall, wherein the compression arrangement further comprises another compression panel pivotally mounted on a connecting edge of another actuation window formed in a rear side of the surrounding wall of the bin body so as to arrange with the at least one compression panel in a symmetrical and opposing manner, wherein each of the at least one compression panel and the another compression panel is configured to be moved between the normal state that is extending upright and the compression position pivotally and downwardly into the receiving cavity about pivotal axes thereof respectively, wherein by flipping the at least one compression panel and the another compression panel from the normal state thereof to the compression state thereof, the upper garbage contained in the upper portion of the receiving cavity is compressed by the at least one compression panel and the another compression panel with respect to the bottom wall of the bin body to move to the lower portion of the receiving cavity and compress the lower garbage contained in the lower portion of the receiving cavity.

10. The trash container, as recited in claim 9, wherein a height of each of the at least one compression panel and the another compression panel is preferred to be equal to or slightly less than a half of a distance between the front side and the rear side of the surrounding wall of the bin body, such that when the at least one compression panel and the another compression panel are flipped down to the compression state thereof, the at least one compression panel and the another compression panel are positioned between the upper portion and the lower portion of the receiving cavity and cover the lower portion of the receiving cavity.

11. The trash container, as recited in claim 10, wherein the compression arrangement further comprises another pivot joint to pivotally mounted the another compression panel to the connecting edge of the another actuation window formed in the upper portion of the rear side of the surrounding wall.

12. The trash container, as recited in claim 11, wherein the another pivot joint is an elongated hinge unit having one end connected to the bottom edge of the another compression panel and another end connected to the connecting edge of the another actuation window, wherein the another pivot joint is configured to support the another compression panel respectively to upwardly extend in the normal state thereof and allow the another compression panel being flipped in and down towards the lower portion of the receiving cavity to the compression state thereof.

13. The trash container, as recited in claim 12, wherein the another compression panel is able to be flipped down inwardly by an actuation force applied thereto, and that the another pivot joint provides a resilient force to move the another compression panel back to the upright normal state after the actuation force applied to the another compression panel is released.

14. The trash container, as recited in claim 1, wherein the compression arrangement further comprises a mounting mechanism which includes a pair of mounting slots vertically and respectively extended from two end portions of a top edge of a rear side of the surrounding wall of the bin body for a predetermined depth and two mounting gaps formed between two end sides of the at least one compression panel and two side edges of the actuation window.

15. The trash container, as recited in claim 14, wherein the mounting mechanism further comprises first and second presser members, the first presser member is pivotally mounted on an outer side of the at least one compression panel and the second presser member is pivotally mounted on an outer surface of the rear side of the surrounding wall by means of two resilient hinge units respectively.

16. The trash container, as recited in claim 9, wherein the compression arrangement further comprises a mounting mechanism which first pair and second pair of mounting gaps, wherein the first pair of mounting gaps is formed between two end sides of the at least one compression panel and two side edges of the actuation window formed in the front side of the surrounding wall and the second pair of mounting gaps is formed between two end sides of the another compression panel and two side edges of the another actuation window formed in the rear side of the surrounding wall.

17. The trash container, as recited in claim 15, wherein the mounting mechanism further comprises a pair of presser members which are pivotally mounted on outer sides of the at least one compression panel and the another compression panel respectively by means of two resilient hinge units, respectively.

18. The trash container, as recited in claim 1, further comprising an actuation mechanism and an outer container receiving the bin body, the compression arrangement and the actuation mechanism therein, wherein the actuation mechanism is configured for actuating the at least one compression panel between the normal state and the compression state, wherein the actuation mechanism comprises a step pedal device and a transmission apparatus, wherein the step pedal device is hinged to a lower portion of the outer container of the trash container and the transmission apparatus comprises at least one pivotal actuator pivotally connected to a middle portion of the outer container of the trash container, and at least one transmission element connecting the step pedal device and the at least one pivotal actuator to allow the step pedal device to drive the pivotal actuator to move pivotally to drive the at least one compression panel to move from the normal state thereof to the compression state thereof.

19. The trash container, as recited in claim 9, further comprising an actuation mechanism and an outer container receiving the bin body, the compression arrangement and the actuation mechanism therein, wherein the actuation mechanism is configured for actuating the at least one compression panel and the another compression panel between the normal state and the compression state, wherein the actuation mechanism comprises a step pedal device and a transmission apparatus, wherein the step pedal device is hinged to a lower portion of the outer container of the trash container and the transmission apparatus comprises a pair of pivotal actuators pivotally connected to a middle portion of the outer container of the trash container, and a pair of transmission elements connecting the step pedal device and the pair of the pivotal actuators to allow the step pedal device to drive the pair of the pivotal actuators to move pivotally to drive the at least one compression panel and the another compression panel to move from the normal state thereof to the compression state thereof respectively.

20. A compression method of a trash container, comprising:
providing at least one compression panel pivotally mounted on a bin body;
moving the at least one compression panel from a normal state, that is extending upright, to a compression state where the at least one compression panel is pivotally and downwardly into a receiving cavity about a pivotal axis of the compression panel to press down and compress any upper garbage contained in an upper portion of the receiving cavity with respect to a bottom wall of the bin body to move to a lower portion of the receiving cavity and compress lower garbage contained in the lower portion of the receiving cavity; and
returning the at least one compression panel to the normal state.
